(19) United States
(12) Patent Application Publication
(10) Pub. No.: US 2024/0377998 A1
(43) Pub. Date: Nov. 14, 2024

(54) SYSTEM, CLIENT APPARATUS, AND CONTROL METHOD THEREFOR

(71) Applicant: CANON KABUSHIKI KAISHA, Tokyo (JP)

(72) Inventor: YUYA TANAKA, Kanagawa (JP)

(21) Appl. No.: 18/655,592

(22) Filed: May 6, 2024

(30) Foreign Application Priority Data
May 8, 2023 (JP) 2023-076458

(51) Int. Cl. G06F 3/12

(52) U.S. Cl. CPC G06F 3/121; G06F 3/1204; G06F 3/1235; G06F 3/1287

(57) ABSTRACT

A control method for a client apparatus communicable with a printer on which a tank containing a recording material is mounted includes transmitting a print instruction to the printer, receiving an instruction of a warning notification from the printer, in a case where the printer is mounted with a tank other than a dedicated tank of a predetermined contract and satisfies a predetermined condition, and executing processing for display as the warning notification indicating that the printer that is a target of the print instruction is mounted with the tank other than the dedicated tank of the predetermined contract, in a case where the client apparatus receives the instruction of the warning notification.

### BACKGROUND

### Field

The present disclosure relates to a system, a client apparatus, and a control method therefor, related to a print service.

### Description of the Related Art

In recent years, a flat-rate print service has been widely provided to a user who uses an image forming apparatus, such as a printer and a multifunction peripheral. The flat-rate print service, which is also called a subscription service, is a service for a user to join a print service for each image forming apparatus. In the flat-rate print service, a contracted image forming apparatus uses a consumable product (e.g., ink tank) dedicated to the flat-rate print service provided by a service provider, and the consumable product dedicated to the flat-rate print service is automatically ordered and delivered each time the ink remaining amount of the consumable product becomes low.

The image forming apparatus having the flat-rate print service contract can continue using a normal ink tank (i.e., tank other than the dedicated ink tank) having been mounted thereon before the contract, but automatic ordering is not performed, even when the ink remaining amount becomes low.

It is therefore necessary to notify the user of a warning that an ink tank other than the dedicated ink tank is mounted at an appropriate timing and in an appropriate form easy for the user to recognize.

Japanese Patent Application Laid-open No. 2020-163595 discusses a technique of displaying a model number of a cartridge on a display panel when the ink remaining amount becomes low in a case where a normal cartridge (i.e., cartridge other than a dedicated cartridge) is mounted on an image forming apparatus, and displaying information about a service provider in a case where a dedicated cartridge is mounted on the image forming apparatus.

However, in a case where the normal cartridge is mounted on the printer with a service provider set thereto, Japanese Patent Application Laid-open No. 2020-163595 displays a message on a display panel of the printer indicating that a suitable cartridge should be installed on the printer, for example, when power is on, but when the ink remaining amount becomes low, the printer displays a model number of the normal cartridge. For this reason, there is a possibility of actually prompting a user to obtain a normal cartridge by referring to the model number and to continue using the normal cartridge. It is also easy for the user to recognize the notification to mount a suitable cartridge if the notification is performed on the apparatus to which the user has given a print instruction at a timing when the ink remaining amount decreases, such as during printing.

As described above, there is no conventional technique of providing a notification that a consumable product other than the dedicated consumable product is mounted on the contracted printer at an appropriate timing and in an appropriate form.

### SUMMARY

According to an aspect of the present disclosure, a system including a printer on which a tank containing a recording material is mounted and a client apparatus communicable with the printer. The printer includes a storage, one or more memories storing instructions, and one or more processors capable of executing the instructions causing the printer to: transmit information including a type of the mounted tank and a remaining amount of the recording material contained in the tank to a printer management server configured to manage information of the printer having a predetermined contract, store, in a case where the type of the mounted tank is a type of a tank other than a dedicated tank of the predetermined contract and a predetermined condition is satisfied, warning instruction information in the storage when the printer receives the warning instruction information from the printer management server, and transmit to the client apparatus, in a case where the warning instruction information is stored in the storage, an instruction of a warning notification when the printer receives a print instruction from the client apparatus. The client apparatus includes one or more memories storing instructions, and one or more processors capable of executing the instructions causing the client apparatus to: transmit the print instruction to the printer; and execute processing for display as the warning notification indicating that the tank other than the dedicated tank of the contract is mounted on the printer that is a target of the print instruction in a case where the client apparatus receives the instruction of the warning notification from the printer.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of an information processing system according to an exemplary embodiment.

FIG. 2 is a block diagram illustrating an example of a hardware configuration of a printer management system according to the exemplary embodiments.

FIG. 3 is a block diagram illustrating an example of a hardware configuration of a printer according to the exemplary embodiment.

FIG. 4 is a sequence diagram illustrating a processing flow up to a warning display for an ink cartridge according to a first exemplary embodiment.

FIG. 5 is a flowchart illustrating an ink status information transmission processing according to the exemplary embodiment.

FIG. 6 is a diagram illustrating an example of printer status (ink status) information according to the exemplary embodiment.

FIG. 7 is a flowchart illustrating a warning display determination processing according to the exemplary embodiment.

FIG. 8 is a flowchart illustrating the warning display determination processing flow according to the first exemplary embodiment.

FIG. 9 is a diagram illustrating an example of an order time information table according to the exemplary embodiment.

FIGS. 10A, 10B, and 10C are examples each illustrating a message dialog according to the exemplary embodiment.

FIG. 11 is a flowchart illustrating a warning display determination processing flow according to a second exemplary embodiment.

FIG. 12 is a flowchart illustrating a warning display determination processing according to a third exemplary embodiment.

FIG. 13 is a sequence diagram illustrating processing up to a warning display of an ink cartridge according to the third exemplary embodiment.

FIG. 14 is a diagram illustrating an example of a warning display management table according to the exemplary embodiment.

### DESCRIPTION OF THE EMBODIMENTS

Hereinbelow, exemplary embodiments of the present disclosure will be described in detail with reference to the attached drawings. Note that the following exemplary embodiments are not intended to limit the present disclosure related to the range of the claims, and not all the combinations of features described in the following exemplary embodiments are necessarily essential.

### <Configuration of Information Processing System>

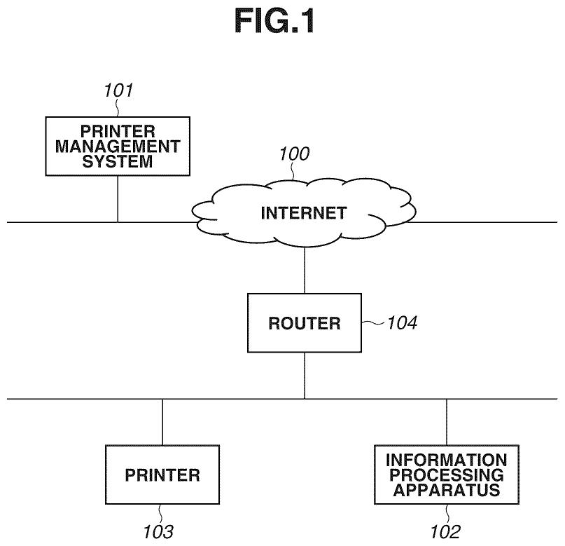

Hereinbelow, a configuration of an information processing system according to a first exemplary embodiment will now be described with reference to FIG. 1.

FIG. 1 is a block diagram illustrating an example of a configuration of an information processing system according to the first exemplary embodiment.

As illustrated in FIG. 1, the information processing system according to the present exemplary embodiment includes a printer management system 101 (printer management server), an information processing apparatus 102 (client apparatus), and a printer 103 serving as an image forming apparatus (image recording apparatus).

The information processing apparatus 102 is a personal computer (PC) having an operating system (OS) installed therein. Alternatively, the information processing apparatus 102 may be a mobile terminal, such as a smartphone and a tablet computer.

The printer 103 is a printer usable in cases where the printer 103 is used by a user both with and without a contract. Hereinbelow, a state where a user uses the printer 103 without a contract with a service provider is referred to and explained as a “normal use state”, and a state where a user uses the printer 103 with a contract is referred to and explained as a “contract use state”.

For example, the service is a flat-rate print service.

The flat-rate print service is a service that allows a “flat-rate print”, which is an example of a contract printing, with a fixed usage fee indicated by contract conditions, within a use period and an upper limit number of printed sheets indicated in the contract conditions. For example, the flat-rate print service provides consumable products and/or replacement products used for the flat-rate printing to a user with a fixed fee, within a range not exceeding the use period and the upper limit number of printed sheets described above. In other words, the contracted dedicated ink tank is automatically delivered when the remaining amount of a recording material in the dedicated ink tank mounted on the printer under a flat-rate print service contract becomes a threshold value or less.

The printer management system 101 is connected to the Internet 100. The printer 103 can communicate with the information processing apparatus 102 and a router 104 via a local area network (LAN). The printer 103 can also be connected to the Internet 100 via the router 104.

The printer management system 101 manages information transmitted from the printer 103. Each communication is controlled via HyperText Transfer Protocols (HTTP) or Extensible Messaging and Presence Protocols (XMPP). The protocols are not limited thereto, and other protocols may be used.

### <Configurations of Printer Management System and Information Processing Apparatus>

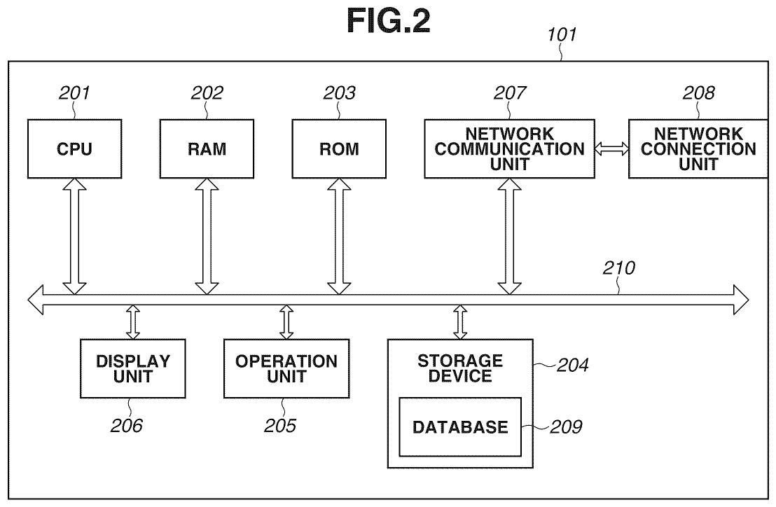

FIG. 2 is a block diagram illustrating an example of a hardware configuration of the printer management system 101. Hereinbelow, the configuration of the printer management system 101 according to the present exemplary embodiment will be described with reference to FIG. 2.

The printer management system 101 includes a central processing unit (CPU) 201, a random access memory (RAM) 202, a read only memory (ROM) 203, a storage device 204, an operation unit 205, a display unit 206, a network communication unit 207, and a network connection unit 208.

The CPU 201 is a central processing unit configured to control units in the printer management system 101. The RAM 202 functions as a work memory used when the CPU 201 executes a program. The ROM 203 is a read only memory for storing a boot program used for a system start-up. The storage device 204 is a device for storing a program executed by the CPU 201, a database 209, and various kinds of information. The storage device 204 is a nonvolatile storage device, such as a magnetic disk and a flash memory.

The operation unit 205 includes a keyboard and a mouse for a user to perform various kinds of input operations. The display unit 206 is composed of, for example, a liquid crystal display (LCD), and displays and presents various kinds of information to a user. The network communication unit 207 is connected to a network such as the Internet 100 via the network connection unit 208 to perform various kinds of communications. The above-described units are connected with each other via a bus 210 and can transmit and receive data to and from each other.

The information processing apparatus 102 is assumed to have a same hardware configuration as the printer management system 101, and a description thereof is omitted. However, the information processing apparatus 102 may have a hardware configuration different from the printer management system 101.

In FIG. 2, the printer management system 101 is configured to have one server (information processing apparatus) but may be configured to have a plurality of servers. In other words, each function is implemented by a plurality of servers operating in corporation. The printer management system 101 may be configured using a cloud computing technology. In the present exemplary embodiment, the configuration configured of one server or a plurality of serves is referred to as a server system.

### <Hardware Configuration of Printer>

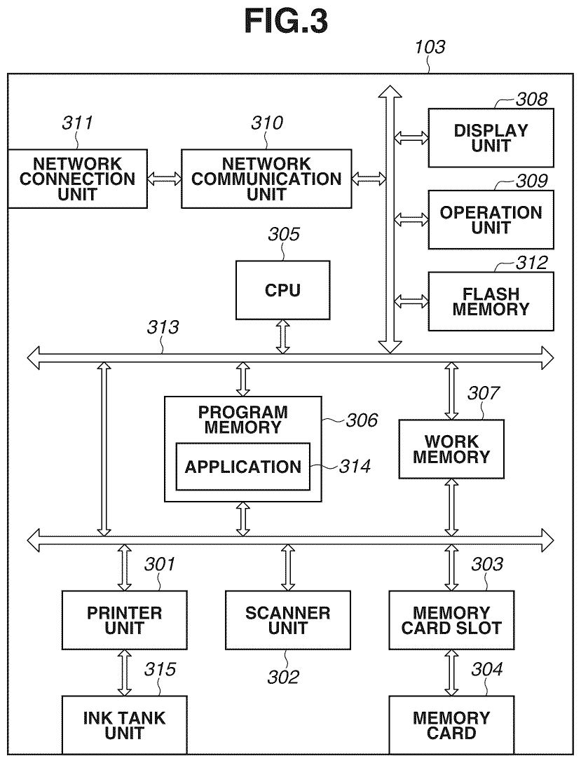

A configuration of the printer 103 will be now described with reference to FIG. 3.

FIG. 3 is a block diagram illustrating an example of a hardware configuration of the printer 103.

The printer 103 includes a printer unit 301, a scanner unit 302, a memory card slot 303, a memory card 304, and an ink tank unit 315. The printer 103 also includes a CPU 305, a program memory 306, a work memory 307, a display unit 308, an operation unit 309, a network communication unit 310, a network connection unit 311, and a flash memory 312.

In the present exemplary embodiment, the printer 103, which is a multifunction peripheral, is described as an example of an image forming apparatus, but the image forming apparatus to which the present exemplary embodiment can be applied may not be a multifunction peripheral. An image forming apparatus, such as a copying machine and a facsimile machine, may be used, and a printer with no scan function may be used. Further, the image forming apparatus according to the present exemplary embodiment is described using an inkjet type printer that performs recording using ink as an example, but the present exemplary embodiment may be applied to an electro-photographic method printer that uses a recording material, such as toner.

The printer 103 achieves the print function by using the printer unit 301 and the scanner function by using the scanner unit 302. The printer 103 achieves the storage function by using the memory card slot 303 and the memory card 304 inserted in the memory card slot 303.

The printer unit 301 records (i.e., prints) an image on a recording medium, such as a print sheet, using an inkjet method, based on image data received from an external source or image data stored in the memory card 304. The printer unit 301 also manages ink remaining amount information and sheet information including the number of stacked sheets information.

The scanner unit 302 optically reads a document set on a platen glass (not illustrated) to convert the read document into digital data, transmits image data converted to a specified file format to an external apparatus via a network, or stores the image data into a storage region (not illustrated) of, for example, a hard disk drive (HDD). The copy function is achieved by transferring to the printer unit 301 the image data generated by the scanner unit 302 reading a document placed on the platen glass, and by the printer unit 301 recording an image on the recording medium based on the transferred image data.

The memory card 304 inserted in the memory card slot 303 stores various kinds of file data. The file data can be read by an external apparatus via a network and edited. The file data can also be stored in the memory card 304 in response to an instruction from an external apparatus.

The CPU 305 is a central processing unit configured to control the units included in the printer 103. The program memory 306 consists of a ROM or the like and stores various kinds of program codes and an application 314 used for communicating with the printer management system 101. A module of the application 314 generates printer status information described below.

The work memory 307 consists of a RAM or the like. The work memory 307 temporarily stores image data when each service is performed or is used to perform buffering.

The display unit 308 is configured of, for example, an LCD, and displays various kinds of information. The operation unit 309 includes switches and other members for a user to perform various kinds of input operations.

The network communication unit 310 connects to the router 104 via the network connection unit 311. In other words, the network communication unit 310 connects to a network such as the Internet 100 via the network connection unit 311 to perform various kinds of communications. Each communication is controlled via HTTP or XMPP. The protocols are not limited thereto, and other protocols may be used.

The flash memory 312 is a non-volatile memory for storing image data or the like received by the network communication unit 310.

The above-described units are connected with each other via a bus 313 and can transmit and receive data to and from each other.

The ink tank unit 315 mounts an ink cartridge including an ink tank that stores ink (recording material) used by the printer unit 301. In a case where toner is used instead of the ink as a recording material, a toner cartridge including a toner tank containing toner may be mounted. If the printer 103 is in a “contract use state”, the printer 103 is possible to mount on the ink tank unit 315 not only an ink cartridge commercially available for purchase at a store, but also a dedicated ink cartridge provided by the service provider. The ink cartridge mounted on the ink tank unit 315 is replaced by a user with another ink cartridge in a case where the contained ink is out or the remaining amount of ink becomes extremely low. Thus, the ink cartridge mounted on the ink tank unit 315 according to the present exemplary embodiment is a type of consumable product replaced with a replacement ink cartridge when the ink is out.

### <Processing Up to Display of Message Dialog>

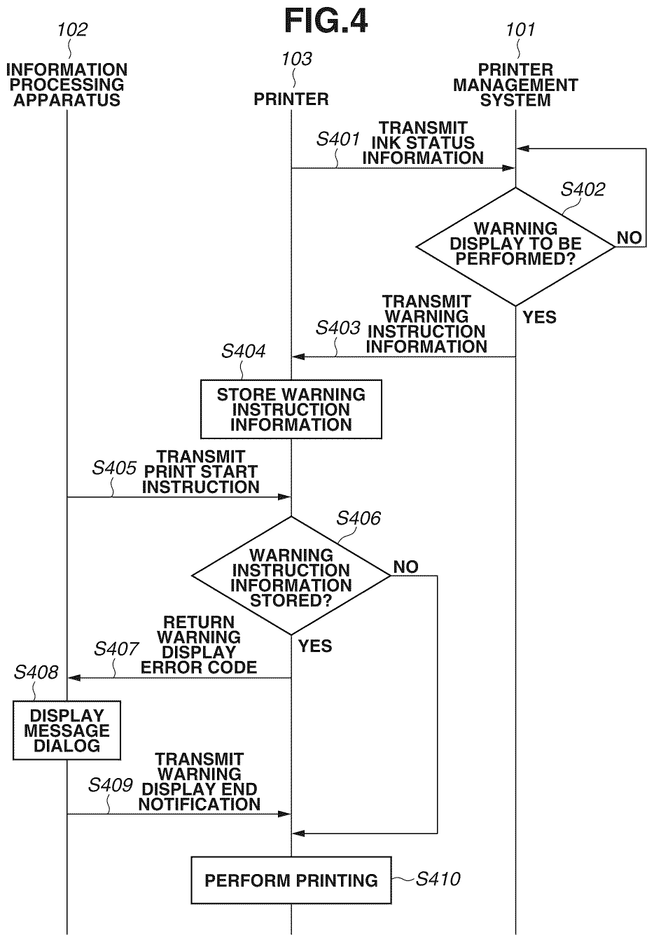

A processing flow up to an ink cartridge warning display will be described below with reference to FIGS. 4 and subsequent drawings.

FIG. 4 is a sequence diagram illustrating the processing flow up to the ink cartridge warning display according the first exemplary embodiment. A series of processing illustrated in FIG. 4 is implemented by the CPUs in the printer 103, the printer management system 101, and the information processing apparatus 102, each loading a program code stored in a disk device or the like into a RAM and executing the loaded program code. Alternatively, part or all of the functions of the steps in FIG. 4 may be implemented by hardware, such as an application specific integrated circuit (ASIC) or an electronic circuit. Hereinbelow, the main body in the processing is a CPU included in each of the printer 103, the printer management system 101, and the information processing apparatus 102.

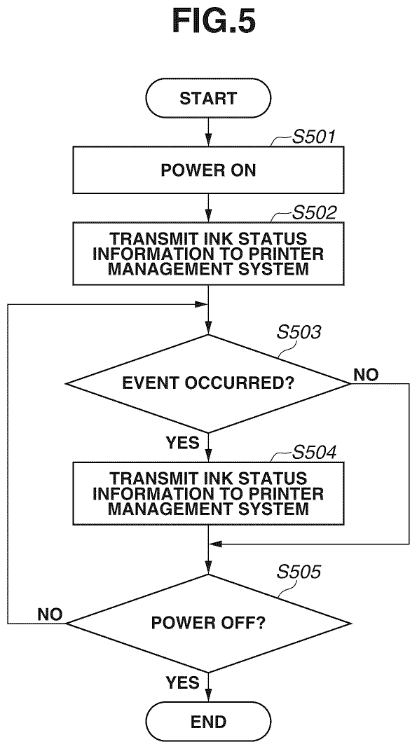

In step S401, the printer 103 transmits printer status information (hereinbelow, referred to as “ink status information”) including ink cartridge information to the printer management system 101. In the present exemplary embodiment, the ink status information is information including an identification information (ID), color information, a type of cartridge, ink remaining amount information, of each ink cartridge currently mounted on the printer 103, and the contents of data are updated depending on the use state of the ink. The processing flow of the printer 103 transmitting the ink status information to the printer management system 101 will now be described with reference to FIG. 5.

FIG. 5 is a flowchart illustrating a processing flow of the printer 103 transmitting the ink status information including the ink cartridge information to the printer management system 101, according to the present exemplary embodiment. A series of processing illustrated in the flowchart in FIG. 5 is implemented by the CPU 305 of the printer 103 loading a program code stored in a disk apparatus or the like into a RAM and executing the loaded program code. It is assumed that the printer 103 is in a power OFF state before starting the series of processing illustrated in the flowchart in FIG. 5. When the CPU 305 of the printer 103 detects pressing of a power button of the printer 103, the processing of the flowchart starts.

In step S501, the CPU 305 turns the printer 103 from the power-off state to the power-on state.

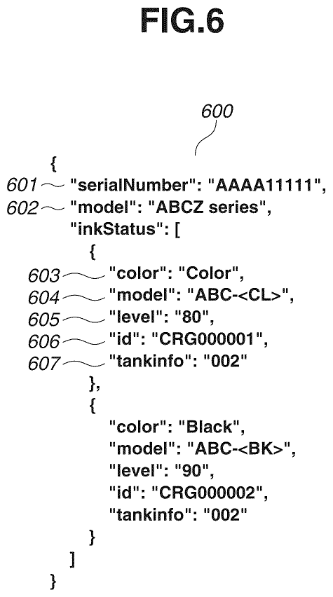

In step S502, the CPU 305 transmits ink status information 600 indicating a status of the printer 103 to the printer management system 101. Here, the ink status information 600 will be described with reference to FIG. 6.

FIG. 6 is a diagram illustrating an example of the ink status information 600.

The ink status information 600 includes a printer serial number 601, a printer model name 602, and cartridge information 603 to cartridge information 607 corresponding to the number of ink cartridges.

The ink cartridge information includes a color 603, a model number 604, an ink remaining amount 605, a unique ID specifying an ink cartridge (hereinbelow, referred to as an “ink cartridge ID”) 606, and ink cartridge type information 607.

The ink cartridge ID 606 is an ID unique to a cartridge regardless of the color of ink contained in the ink cartridge. For example, an ink cartridge with “CRG00001” appended thereto can be uniquely identified in the information processing system.

At least one of two types of “dedicated” and “commercially available” is set to the ink cartridge type information 607. For example, the type “dedicated” is assigned to “001”, and the type “commercially available” to “002”.

The type “dedicated” indicates an ink cartridge dedicated to the flat-rate print service. Hereinbelow, the ink cartridge of the type “dedicated” is referred to as a dedicated ink cartridge (flat-rate service dedicated consumer product). The printer 103 can perform flat-rate printing during when the dedicated ink cartridge is mounted. The dedicated ink cartridge is supplied from the service provider to the user who has signed a contract for the printer 103.

The type “commercially available” indicates an ink cartridge other than the dedicated ink cartridge and is a commercially available ink cartridge that a user can purchase at an electrical appliance store or a mail-order site.

Now, the description returns to the flowchart in FIG. 5.

In step S503, the CPU 305 determines whether an event has occurred. The event is that any operation is performed on the printer 103, for example, printing or copying is performed, the cover of the printer 103 is opened, or the cover of the printer 103 is closed from the open state. Thus, in a case where an ink cartridge is replaced, the CPU 305 determines that an event has occurred.

In step S503, in a case where the CPU 305 determines that an event has occurred (YES in step S503), the CPU 305 advances the processing to step S504.

In step S504, the CPU 305 transmits the ink status information 600 to the printer management system 101, and then advances the processing to step S505.

In contrast, in a case where the CPU 305 determines that an event has not occurred (NO in step S503), the CPU 305 advances the processing to step S505.

In step S505, the CPU 305 determines whether the printer 103 is powered OFF. In a case where the printer 103 is not powered OFF (NO in step S505), the CPU 305 returns the processing to step S503, to repeat the processing from step S503.

In contrast, in a case where the printer 103 is powered OFF (YES in step S505), the CPU 305 ends the series of processing in the flowchart.

As described above, in the present exemplary embodiment, the CPU 305 of the printer 103 transmits the ink status information 600 to the printer management system 101 at a timing of the power-on, and a timing at which an event (e.g., printing or copying, or open/close of the cover) is performed.

Now, the description returns to the sequence in FIG. 4.

Upon receiving the ink status information 600, the CPU 201 of the printer management system 101 advances the processing to step S402.

In step S402, the CPU 201 of the printer management system 101 receives the ink status information 600 and performs a warning display determination with reference to the received ink status information 600.

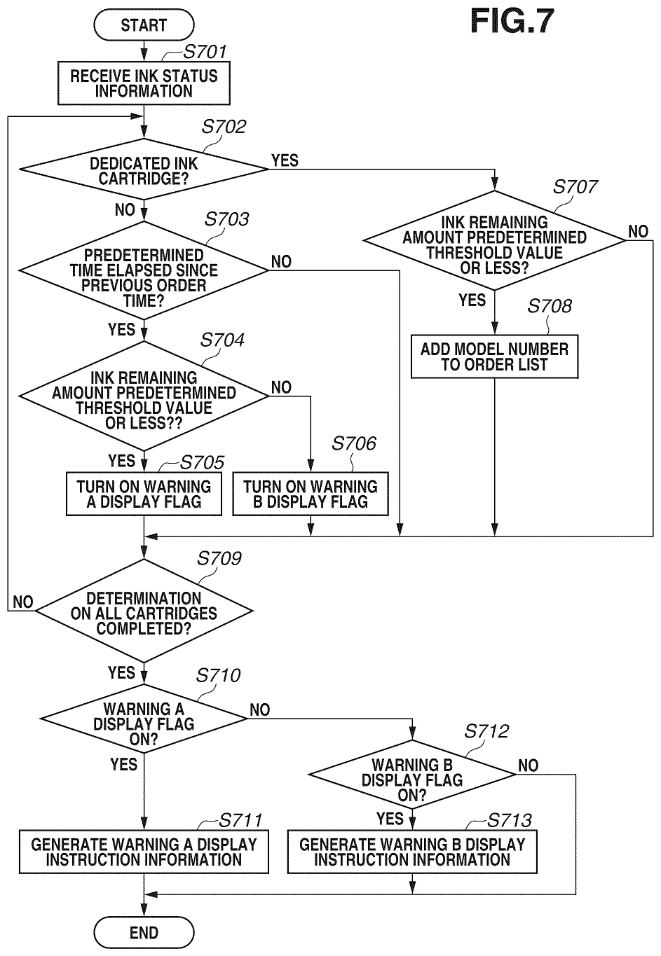

The warning display determination processing performed by the CPU 201 will now be described with reference to FIG. 7.

FIG. 7 is a flowchart illustrating an example of the warning display determination processing of the printer management system 101 according to the first exemplary embodiment. Processing performed in each step in FIG. 7 is implemented by the CPU 201 of the printer management system 101 loading a program code stored in the ROM 203 or the storage device 204 into the RAM 202 and executing the loaded program code.

In step S701, upon receiving the ink status information 600 transmitted from the printer 103, the CPU 201 of the printer management system 101 advances the processing to step S702.

In step S702, the CPU 201 determines whether the mounted ink cartridge is a dedicated ink cartridge (dedicated tank), with reference to the ink cartridge type information 607 included in the ink status information 600 received in step S701 described above. In a case where the mounted ink cartridge is not a dedicated ink cartridge (NO in step S702), the CPU 201 advances the processing to step S703.

In step S703, the CPU 201 determines whether a predetermined time has elapsed since the previous order time of the dedicated ink cartridge of the same color as that of the ink cartridge determined not to be the dedicated ink cartridge (cartridge other than the dedicated tank) in step S702 described above.

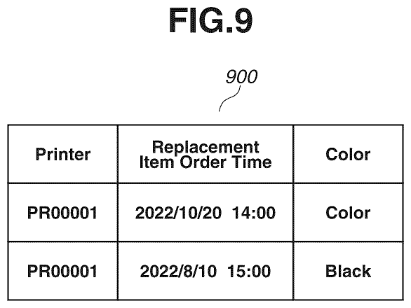

Here, the previous order time information will be described with reference to FIG. 9.

FIG. 9 is a diagram illustrating an example of an order time information table 901 stored in the database 209 of the printer management system 101.

The order time information table 901 stores printer serial number information, replacement item order time information, and color information.

The first order of the dedicated ink cartridge serving as a replacement item is ordered immediately after joining the flat-rate service, and thereafter, a dedicated ink cartridge to be replaced is ordered when the ink remaining amount of the dedicated ink cartridge becomes a threshold value or less. Every time the replacement item is ordered, the replacement item order time is updated. In other words, the replacement item order time information is information obtained by associating the serial number of the printer 103 and the latest replacement item order time of the ink cartridge for each color of the ink cartridge.

The description now returns to the flowchart in FIG. 7.

In step S703, in a case where the predetermined time has not elapsed since the previous dedicated ink order time (NO in step S703), the CPU 201 advances the processing to step S709.

On the other hand, in a case where the predetermined time has elapsed since the previous dedicated ink order time (YES in step S703), the CPU 201 advances the processing to step S704.

In step S704, the CPU 201 determines whether the ink remaining amount of the ink cartridge determined not to be the dedicated ink cartridge in step S702 is a predetermined threshold value or less. For example, the predetermined threshold value may be any value, such as 0, 10, and 20, indicating an ink remaining amount ratio. In step S704, in a case where the ink remaining amount is the threshold value or less (YES in step S704), the CPU 201 advances the processing to step S705.

In step S705, the CPU 201 turns ON a warning A display flag in the RAM 202 and advances the processing to step S709.

On the other hand, in a case where the ink remaining amount is more than the predetermined threshold value (No in step S704), the CPU 201 advances the processing to step S706.

In step S706, the CPU 201 turns ON a warning B display flag in the RAM 202 and advances the processing to step S709.

The warning A display flag and the warning B display flag are held in the RAM 202 in an OFF state when the flowchart starts.

In contrast, in step S702, in a case where the CPU 201 determines that the ink cartridge included in the ink status information 600 received in step S701 is the dedicated ink cartridge (YES in step S702), the CPU 201 advances the processing to step S707.

In step S707, the CPU 201 determines whether the ink remaining amount of the ink cartridge is the predetermined threshold value or less, similarly in step S704 described above. In step S707, in a case where the ink remaining amount is the threshold value or less (YES in step S707), the CPU 201 advances the processing to step S708.

In step S708, the CPU 201 adds to and holds in the order list the model number of the ink cartridge determined in step S707 that the ink remaining amount is the predetermined threshold value or less described above. The ink cartridge added to the order list becomes an order target of the replacement item. After the processing in step S708, the CPU 201 advances the processing to step S709.

In a case where the ink remaining amount is more than the predetermined threshold value (No in step S707), the CPU 201 advances the processing to step S709.

In step S709, the CPU 201 determines whether the warning determination processing has been performed on the ink cartridges of all colors mounted on the printer 103 (i.e., processing in steps S702 to S709 is performed).

In a case where the warning determination processing has not been performed on the ink cartridges of all colors (NO in step S709), the CPU 201 returns the processing to step S702 and repeats the processing in steps S702 to S709 until the warning determination processing on the ink cartridges of all the colors is completed.

On the other hand, in a case where the warning determination processing is completed on the ink cartridges of all the colors mounted on the printer 103 (YES in step S709), the CPU 201 advances the processing to step S710.

In step S710, the CPU 201 determines whether the warning A display flag is ON. In a case where the warning A display flag is ON (YES in step S710), the CPU 201 advances the processing to step S711.

In step S711, the CPU 201 generates warning A display instruction information for instructing the information processing apparatus 102 to display a message dialog 1001 described below and ends the warning display determination processing. In this case, the warning display determination result in step S402 in FIG. 4 becomes “YES”.

In a case where the warning A display flag is OFF (NO in step S710), the CPU 201 advances the processing to step S712.

In step S712, the CPU 201 determines whether the warning B display flag is ON. In step S712, in a case where the warning B display flag is ON (YES in step S712), the CPU 201 advances the processing to step S713.

In step S713, the CPU 201 generates the warning B display instruction information instructing the information processing apparatus 102 to display a message dialog 1002 described below and ends the warning display determination processing. In this case, the warning display determination result in step S402 in FIG. 4 becomes “YES”.

In a case where the warning B display flag is OFF (NO in step S712), the CPU 201 ends the warning display determination processing. In this case, the warning display determination result in step S402 in FIG. 4 becomes “NO”.

The description now returns to the sequence in FIG. 4.

In a case where the warning display determination result in step S402 is “NO” (i.e., warning display is not to be performed), the CPU 201 waits for receiving the ink status information 600.

In a case where the warning display determination result in step S402 is “YES” (i.e., warning display is to be performed), the CPU 201 advances the processing to step S403.

In step S403, the CPU 201 transmits to the printer 103 the warning instruction information generated in step S402 (i.e., the warning A display instruction information generated in step S711, or the warning B display instruction information generated in step S713).

In step S404, upon receiving the warning instruction information, the printer 103 stores (holds) the received warning instruction information in the work memory 307.

In step S405, the information processing apparatus 102 activates a print application or a printer driver stored in the RAM 202 to transmit a print start instruction.

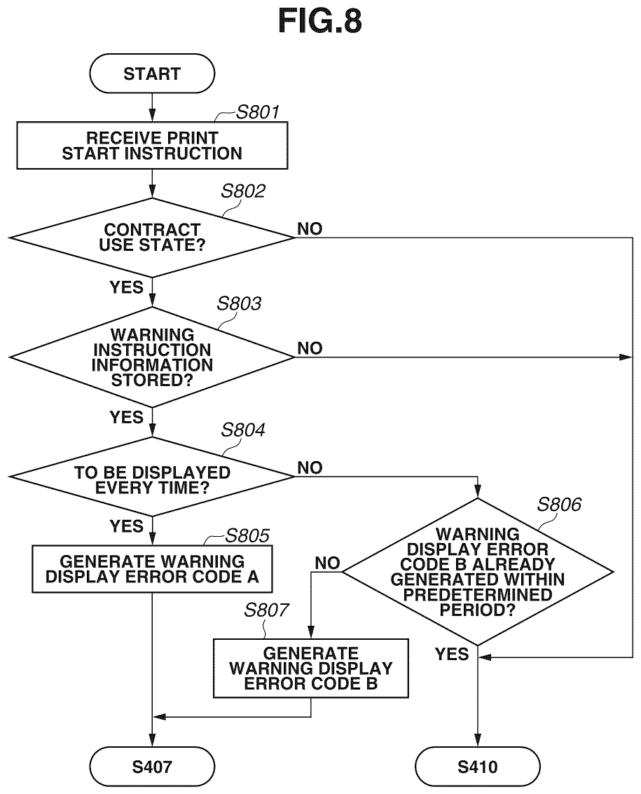

In step S406, upon receiving the print start instruction, the printer 103 performs a warning display determination processing. Here, the warning display determination processing performed by the printer 103 will be described with reference to FIG. 8.

FIG. 8 is a flowchart illustrating an example of a processing flow of the printer 103 performing the warning display determination according to the first exemplary embodiment. A series of processing illustrated in the flowchart in FIG. 8 is implemented by the CPU 305 of the printer 103 loading a program code stored in a disk apparatus or the like into a RAM and executing the loaded program code.

In step S801, upon receiving a print start instruction from the information processing apparatus 102, the CPU 305 of the printer 103 advances the processing to step S802.

In step S802, the CPU 305 determines whether the printer 103 is in a contract use state. For example, information indicating the contract use state may be stored in the flash memory 312, or the printer 103 may inquire of the printer management system 101 to obtain information about whether the printer 103 is in a contract use state.

In a case where the printer 103 is not in a contract use state (NO in step S802), the CPU 305 ends the warning display determination processing and advances the processing to step S410 in FIG. 4.

In contrast, in a case where the printer 103 is in a contract use state (YES in step S802), the CPU 305 advances the processing to step S803.

In step S803, the CPU 305 determines whether the warning instruction information (i.e., warning A display instruction information or warning B display instruction information) is stored in the work memory 307. In a case where the warning instruction information is not stored in the work memory 307 (NO in step S803), the CPU 305 ends the warning display determination processing and advances the processing to step S410 in FIG. 4.

In contrast, in a case where the warning instruction information is stored in the work memory 307 (YES in step S803), the CPU 305 advances the processing to step S804.

In step S804, the CPU 305 determines whether the warning is a warning to be displayed every time before printing or to be displayed once a day before printing, with reference to the warning instruction information. In the present exemplary embodiment, in a case where the warning instruction information is the warning A display instruction information, the CPU 305 determines the warning to be displayed every time before printing, and in a case where the warning instruction information is the warning B display instruction information, the CPU 305 determines the warning to be displayed once a day before printing. The warning B display instruction information may be a warning to be displayed arbitrary times.

In a case where the CPU 305 determines that the warning is to be displayed every time before printing (YES in step S804), the CPU 305 advances the processing to step S805.

In step S805, the CPU 305 generates a warning display error code A and ends the warning display determination processing. The CPU 305 then advances the processing to step S407 in FIG. 4.

In contrast, in a case where the CPU 305 determines the warning not to be displayed every time before printing (NO in step S804), the CPU 305 advances the processing to step S806.

In step S806, the CPU 305 determines whether a warning display error code B has already been generated within 24 hours (within a predetermined period). In a case where the CPU 305 determines that the warning display error code B has already been generated within 24 hours (YES in step S806), the CPU 305 ends the warning display determination processing and advances the processing to step S410 in FIG. 4.

In contrast, in a case where the CPU 305 determines that the warning display error code B has not been generated within 24 hours (NO in step S806), the CPU 305 advances the processing to step S807.

In step S807, the CPU 305 generates the warning display error code B and ends the warning display determination processing. The CPU 305 then advances the processing to step S407 in FIG. 4.

The description now returns to the sequence in FIG. 4.

In step S407, the printer 103 returns to the information processing apparatus 102 the warning display error code (i.e., warning display error code A or warning display error code B) generated by the warning display instruction determination processing in step S406.

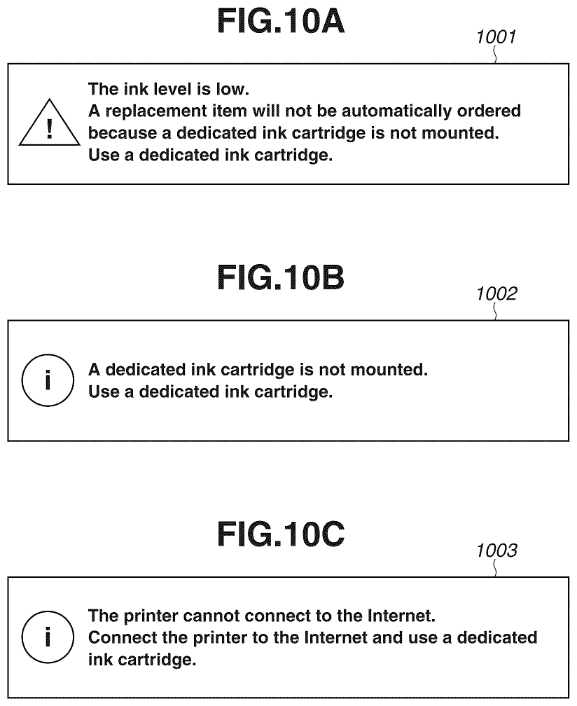

In step S408, upon receiving the warning display error code from the printer 103, the print application of the information processing apparatus 102 displays a message dialog (warning notification) based on the received warning display error code. In the present exemplary embodiment, in a case where the warning display error code A is received, the print application of the information processing apparatus 102 displays the message dialog 1001 illustrated in FIG. 10A. On the other hand, in a case where the warning display error code B is received, the print application of the information processing apparatus 102 displays a message dialog 1002 illustrated in FIG. 10B.

Contents of the warnings displayed by the information processing apparatus 102 will now be described with reference to FIGS. 10A, 10B, and 10C.

FIGS. 10A, 10B, and 10C are examples of message dialogs displayed by the information processing apparatus 102.

The message dialog 1001 is an example illustrating a warning message A.

The message dialog 1001 displays a message indicating that the ink remaining amount of the ink cartridge is low, a dedicated ink cartridge is not mounted, and a replacement item will not be automatically ordered, and the like.

The message dialog 1002 is an example illustrating a warning message B.

The message dialog 1002 displays, for example, a message indicating that a dedicated ink cartridge is not mounted.

The description now returns to the sequence in FIG. 4.

In step S409, upon detecting that the message dialog displayed in step S408 is closed by the user's operation, the information processing apparatus 102 transmits a warning display end notification to the printer 103.

In step S410, upon receiving the warning display end notification, the printer 103 performs printing based on the print request received from the information processing apparatus 102 in step S801 in FIG. 8.

### <Effect of First Exemplary Embodiment>

In the present exemplary embodiment, in a case where the printer 103 is in a flat-rate print service contract use state and a cartridge other than the dedicated ink cartridge is mounted, a message dialog is displayed before the printer 103 starts printing, when a print instruction is given from the information processing apparatus 102 to the printer 103. With this message dialog, a user can notice, for example, that an ink cartridge other than the dedicated ink cartridge is mounted, and that a replacement item will not be delivered.

The printer management system 101 can also instruct the printer 103 to control a display timing whether to display a message dialog every time or once a day before a start of printing, and the content of the message, depending on the ink remaining amount.

Further, in the example described above, the print application of the information processing apparatus 102 displays the message dialog, but the present exemplary embodiment is not limited thereto. For example, a printer driver installed in the information processing apparatus 102 may display the message dialog.

In the present exemplary embodiment, the example of the printer management system 101 having the order information table by itself is described, but it is not limited thereto. For example, an external table stored in an external apparatus may be managed by reading and updating the external table.

In the present exemplary embodiment, ink is the management target, but it is not limited to ink. As long as a recording material is contained in a cartridge serving as a consumable product, for example, toner may be the management target.

In a second exemplary embodiment, a configuration will be described to perform a warning message display when the printer 103 is not connected to the Internet 100 and cannot communicate with the printer management system 101. In the present exemplary embodiment, descriptions of contents similar to the contents in the first exemplary embodiment are omitted, and points different from the first exemplary embodiment will be mainly described.

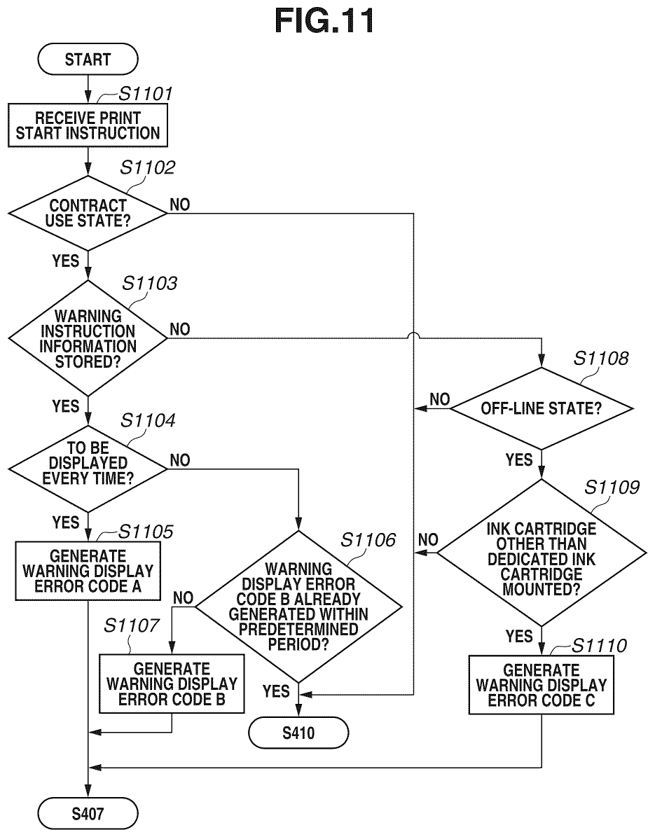

FIG. 11 is a flowchart illustrating an example of a processing flow of the printer 103 according to the second exemplary embodiment performing a warning display determination. A series of pieces of processing illustrated in the flowchart in FIG. 11 is implemented by the CPU 305 of the printer 103 loading a program code stored in a disk apparatus or the like into a RAM and executing the loaded program code.

Processing performed in steps S1101 to S1107 is similar to that performed in steps S801 to S807 in FIG. 8, and thus descriptions thereof are omitted.

In the present exemplary embodiment, in a case where the work memory 307 does not store the warning instruction information (NO in step S1103), the CPU 305 advances the processing to step S1108.

In step S1108, the CPU 305 of the printer 103 determines whether the printer 103 is in an off-line state (i.e., state unconnectable to the Internet 100). In step S1108, in a case where the printer 103 is not in an off-line state (i.e., in an on-line state) (NO in step S1108), the CPU 305 ends the warning display determination processing, and advances the processing to step S410 in FIG. 4.

In contrast, in a case where the printer 103 is in an off-line state (YES in step S1108), the CPU 305 advances the processing to step S1109.

In step S1109, the CPU 305 determines whether an ink cartridge other than the dedicated ink cartridge is mounted. In step S1109, in a case where the dedicated ink cartridge is mounted (NO in step S1109), the CPU 305 ends the flowchart, and advances the processing to step S410 in FIG. 4.

On the other hand, a cartridge other than the dedicated ink cartridge is mounted (YES in step S1109), the CPU 305 advances the processing to step S1110.

In step S1110, the CPU 305 generates a warning display error code C. In the present exemplary embodiment, the warning display error code C is information instructing the information processing apparatus 102 to display a message dialog 1003 illustrated in FIG. 10C. After the processing in step S1110, the CPU 305 ends the warning display determination processing, and advances the processing to step S407 in FIG. 4.

### <Effect of Second Exemplary Embodiment>

According to the present exemplary embodiment, in a state where the printer 103 is unable to communicate with the printer management system 101 due to, for example, an unconnected state of the printer 103 to the Internet 100, the printer 103 can display the warning message in a case where an ink cartridge other than the dedicated ink cartridge is mounted, regardless of the contract use state.

The case of the off-line state (i.e., state not connected to the Internet 100) of the printer 103 is described above, but other states in which the printer 103 cannot communicate with the printer management system 101 due to, for example, a system down of the printer management system 101 are similar to the above-described state. In this case, however, the message “The printer cannot connect to the Internet” is to be replaced by a message “The printer cannot communicate with the printer management system” or the like.

In a third exemplary embodiment, a configuration will be described in which the information processing apparatus 102 communicates with the printer management system 101 to perform a warning display. In the third exemplary embodiment, descriptions of contents common to the contents in the first exemplary embodiment are omitted as appropriate, and points different from the first exemplary embodiment will be mainly described.

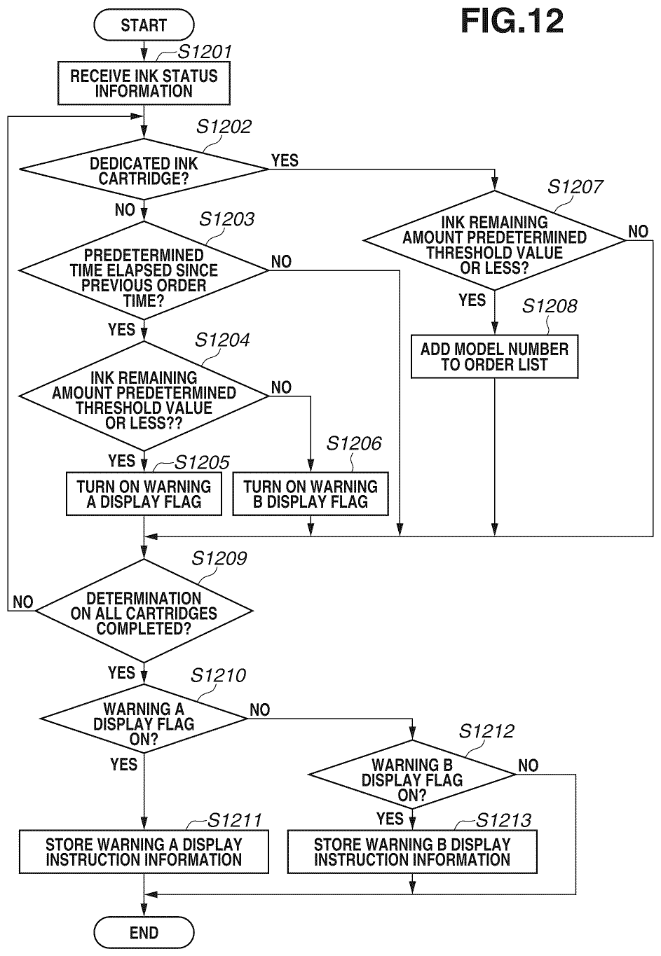

FIG. 12 is a flowchart illustrating an example of a warning display determination processing of the printer management system 101 according to the third exemplary embodiment. Processing in each step in FIG. 12 is implemented by the CPU 201 of the printer management system 101 loading a program code stored in the ROM 203 or the storage device 204 into the RAM 202 and executing the loaded program code.

Processing performed in steps S1201 to S1210, and S1212 is similar to that performed in steps S701 to S710, and S712, and descriptions thereof are omitted.

In the third exemplary embodiment, in a case where the warning A display flag is ON (YES in step S1110), the CPU 201 advances the processing to step S1211.

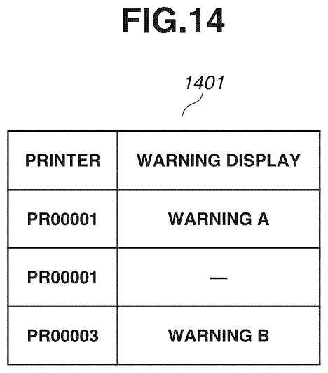

In step S1211, the CPU 201 stores the warning A display instruction information for instructing the information processing apparatus 102 to display the message dialog 1001 into a warning display management table 1401 illustrated in FIG. 14 described below and ends the warning display determination processing. In this case, the warning display determination result in step S402 in FIG. 4 is “YES”.

In a case where the warning B display flag is ON (YES in step S1212), the CPU 201 advances the processing to step S1213.

In step S1213, the CPU 201 stores the warning B display instruction information for instructing the information processing apparatus 102 to display the message dialog 1002 into the warning display management table 1401 and ends the warning display determination processing. In this case, the warning display determination result in step S402 in FIG. 4 is “YES”.

FIG. 14 is a diagram illustrating an example of the warning display management table 1401 stored in the database 209 of the printer management system 101.

The warning display management table 1401 stores serial numbers of the printers 103 and types of warning displays respectively in an associated manner.

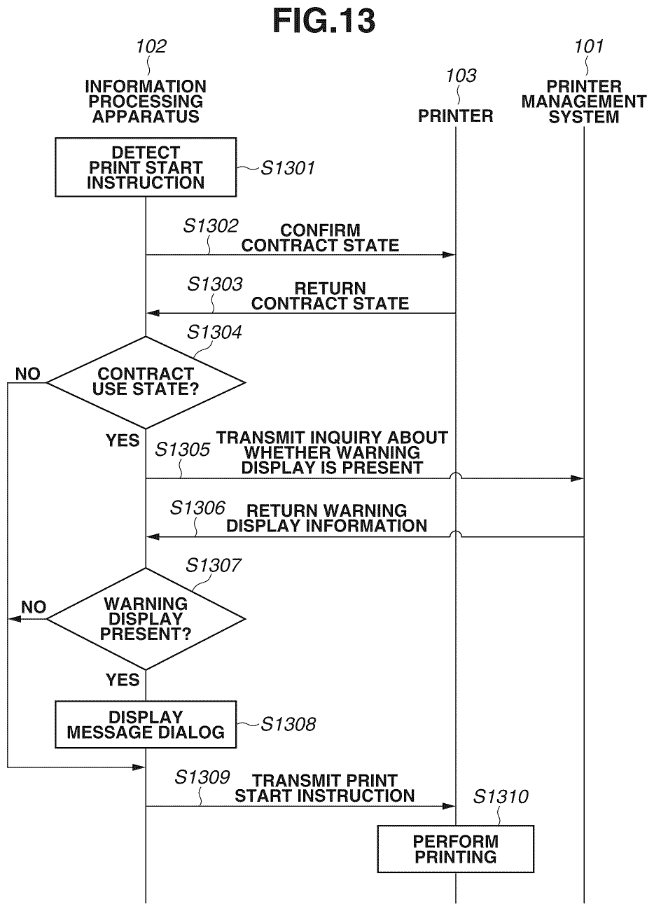

FIG. 13 is a sequence diagram illustrating a processing flow up to a warning display of the ink cartridge according to the third exemplary embodiment. Processing in each step in FIG. 13 is implemented by the CPU 201 of the information processing apparatus 102 loading a program code stored in the ROM 203 or the storage device 204 into the RAM 202 and executing the loaded program code.

In step S1301, upon detecting a print start instruction from a print application or a printer driver stored in the RAM 202, the information processing apparatus 102 advances the processing to step S1302.

In step S1302, the information processing apparatus 102 transmits a contract use state confirmation notification to the printer 103.

In step S1303, upon receiving the contract use state confirmation notification, the printer 103 returns the contract use state confirmation notification to the information processing apparatus 102.

In step S1304, upon receiving the response of the contract use state confirmation notification, the information processing apparatus 102 determines whether the printer 103 is in a contract use state. In a case where the printer 103 is not in a contract use state (NO in step S1304), the information processing apparatus 102 advances the processing to step S1309.

On the other hand, the printer 103 is in a contract use state (YES in step S1304), the information processing apparatus 102 advances the processing to step S1305.

In step S1305, the information processing apparatus 102 transmits to the printer management system 101 an inquiry about whether a warning display including a serial number is present.

In step S1306, upon receiving the inquiry about whether the warning display is present transmitted from the information processing apparatus 102, the printer management system 101 searches the warning display management table 1401 for the serial number included in the inquiry about whether the warning display is present and returns the warning display information. For example, if the warning display value in the warning display management table 1401 is a “warning A” or a “warning B”, the printer management system 101 returns the warning display information with the warning-present being set, and with the display content “warning message A” or “warning message B” being set. In contrast, if the warning display value is “-”, the printer management system 101 returns the warning display information with “no warning display” being set therein.

In step S1307, upon receiving the response of the warning display information, the information processing apparatus 102 determines whether the warning display is present based on the warning display information. In step S1307, in a case where no warning display is present (NO in step S1307), the information processing apparatus 102 advances the processing to step S1309.

In contrast, in a case where the warning display is present (YES in step S1307), the information processing apparatus 102 advances the processing to step S1308.

In step S1308, the information processing apparatus 102 displays a message dialog based on the display content included in the received warning display information. For example, if the display content included in the received warning display information is the “warning message A”, the information processing apparatus 102 displays the message dialog 1001 illustrated in FIG. 10A, and if the display content included in the received warning display information is the “warning message B”, the information processing apparatus 102 displays the message dialog 1002 illustrated in FIG. 10B.

Upon detecting the closing of the message dialog displayed in step S1308, the information processing apparatus 102 advances the processing to step S1309.

In step S1309, the information processing apparatus 102 transmits a print start instruction to the printer 103.

In step S1310, upon receiving the print start instruction, the printer 103 performs printing based on the print start instruction.

### <Effect of Third Exemplary Embodiment>

According to the present exemplary embodiment, the information processing apparatus 102 can directly communicate with the printer management system 101 to display the warning message not via the printer 103.

When the ink cartridge is replaced, the CPU 305 of the printer 103 deletes the warning instruction information stored in the work memory 307. In this case, the CPU 305 determines that an event has occurred (YES in step S503) and transmits the ink status information to the printer management system 101 in step S504.

In a case where the print instruction transmitted from the information processing apparatus 102 to the printer 103 is an instruction of “reservation printing”, the warning display may be performed on the display unit 308 of the printer 103. The “reservation printing” is referred to as a printing in which a print job transmitted from the information processing apparatus 102 is once reserved in the flash memory 312 without immediately outputting the print job, and the printing is started when a user gives a print start instruction via the operation unit 309.

Even when a cartridge other than the cartridge dedicated to the printer 103 is mounted, a message such as “It is not the dedicated ink cartridge, so a replacement item will not be ordered. Use a dedicated ink cartridge” may be displayed on the display unit 308 of the printer 103.

As described above, according to the exemplary embodiments, it is possible to notify a user of the fact at a more suitable timing (print instruction timing), and in a more appropriate form (form displayed by the print application or the like) in a case where a consumable product (ink tank) mounted on an image forming apparatus (printer) while a contract is valid is a consumable product other than the dedicated consumable product. In this way, it is possible to allow a user to easily recognize that a consumable product other than the dedicated consumable product is mounted or automatic ordering will not be performed.

The configurations and the contents of the various kinds of data described above are not limited thereto, and obviously can be configured with various configurations and contents depending on their intended usages and purposes.

The examples of the embodiments have been described above, but the present disclosure can be realized in a form of, for example, a system, an apparatus, a method, a program, or a storage medium. More specifically, the present disclosure can be applied to a system configured of a plurality of apparatuses or an apparatus configured of one apparatus.

All of the configurations obtained by combining the above-described exemplary embodiments are included in the present disclosure.

The present disclosure can be realized by processing of supplying a program for implementing one or more functions of the above-described exemplary embodiments to a system or an apparatus via a network or a storage medium, and one or more processors in the system or the apparatus reading and executing the program. The present disclosure can also be realized by a circuit (e.g., application specific integrated circuits (ASIC)) that can implement one or more functions.

The present disclosure can also be applied to a system configured of a plurality of apparatuses, or an apparatus configured of one apparatus.

The present disclosure is not limited to the above-described exemplary embodiments, and various modifications (including organic combinations of the exemplary embodiments) are possible based on the gist of the present disclosure, and the present disclosure is not intended to exclude these modifications from the range of the present disclosure. In other words, all of the configurations obtained by combining the above-described exemplary embodiments and modifications are also included in the present disclosure.

According to the present disclosure, it is possible to notify a user of the fact at a suitable timing and in an appropriate form in a case where a consumable product mounted on a printer having a valid contract is a consumable product other than a dedicated consumable product.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-076458, filed May 8, 2023, which is hereby incorporated by reference herein in its entirety.

What is claimed is:

1. A system comprising:
a printer on which a tank containing a recording material is mounted; and
a client apparatus communicable with the printer,
wherein the printer includes:
a storage;
one or more memories storing instructions, and
one or more processors capable of executing the instructions causing the printer to:
transmit information including a type of the mounted tank and a remaining amount of the recording material contained in the tank to a printer management server configured to manage information of the printer having a predetermined contract;
store, in a case where the type of the mounted tank is a type of a tank other than a dedicated tank of the predetermined contract and a predetermined condition is satisfied, warning instruction information in the storage when the printer receives the warning instruction information from the printer management server; and
transmit to the client apparatus, in a case where the warning instruction information is stored in the storage, an instruction of a warning notification when the printer receives a print instruction from the client apparatus, and
wherein the client apparatus includes:
one or more memories storing instructions, and
one or more processors capable of executing the instructions causing the client apparatus to:
transmit the print instruction to the printer; and
execute processing for display as the warning notification indicating that the tank other than the dedicated tank of the contract is mounted on the printer that is a target of the print instruction in a case where the client apparatus receives the instruction of the warning notification from the printer.

2. The system according to claim 1, wherein the case where the predetermined condition is satisfied is a case where at least one of a first condition in which the remaining amount of the recording material in the mounted tank is a threshold value or less and a second condition in which a predetermined time has elapsed since the contract has been made.

3. The system according to claim 2,
wherein instruction information of the warning notification includes instruction information of a first warning notification transmitted from the printer management server in a case where both of the first condition and the second condition are satisfied as the predetermined condition, and instruction information of a second warning notification transmitted from the printer management server in a case where the second condition is satisfied but the first condition is not satisfied as the predetermined condition, and
wherein, in a case where the instruction information of the first warning notification is stored in the storage, an instruction of the first warning notification is transmitted, and in a case where the instruction information of the second warning notification is stored in the storage, an instruction of the second warning notification is transmitted when the instruction of the second warning notification has not been performed within a predetermined period.

4. The system according to claim 1, wherein the processing is executed by a printer driver or a print application that has generated the print instruction.

5. The system according to claim 1, wherein the predetermined contract is a contract based on which a dedicated tank of the contract is automatically delivered when the remaining amount of the recording material contained in the tank mounted on the printer having the contract is a threshold value or less.

6. The system according to claim 1, wherein, in a case where the instruction information of the warning notification is not stored in the storage and the printer cannot communicate with the printer management server, the instruction of the warning notification is transmitted to the client apparatus when the tank other than the dedicated tank is mounted.

7. The system according to claim 1,
wherein the client apparatus further transmits an end notification of a warning display to the printer when the display of the warning notification is ended by a user's operation, and
wherein the printer further executes printing based on the print instruction when the printer receives the end notification of the warning display.

8. The system according to claim 1, wherein the recording material is ink or toner.

9. A client apparatus communicable with a printer on which a tank containing a recording material is mounted, the client apparatus comprising:
one or more memories storing instructions, and
one or more processors capable of executing the instructions causing the client apparatus to:
transmit a print instruction to the printer;
receive an instruction of a warning notification from the printer in a case where the printer is mounted with a tank other than a dedicated tank of a predetermined contract and satisfies a predetermined condition; and
execute processing for display as the warning notification indicating that the tank other than the dedicated tank of the contract is mounted on the printer that is a target of the print instruction, in a case where the instruction of the warning notification is received.

10. The client apparatus according to claim 9, wherein the case where the predetermined condition is satisfied is a case where at least one of a first condition in which a remaining amount of the recording material in the mounted tank is a threshold value or less, and a second condition in which a predetermined time has elapsed since the contract has been made.

11. The client apparatus according to claim 10,
wherein the instruction of the warning notification includes an instruction of a first warning notification and an instruction of a second warning notification, and
wherein the instruction of the first warning notification is received in a case where the printer satisfies both the first condition and the second condition as the predetermined condition, and the instruction of the second warning notification is received in a case where the printer satisfies the second condition but does not satisfy the first condition as the predetermined condition and has not transmitted the instruction of the second warning notification within a predetermined period.

12. A control method for a client apparatus communicable with a printer on which a tank containing a recording material is mounted, the control method comprising:
transmitting a print instruction to the printer;
receiving an instruction of a warning notification from the printer, in a case where the printer is mounted with a tank other than a dedicated tank of a predetermined contract and satisfies a predetermined condition; and
executing processing for display as the warning notification indicating that the printer that is a target of the print instruction is mounted with the tank other than the dedicated tank of the predetermined contract, in a case where the client apparatus receives the instruction of the warning notification.
